(19) United States
(12) Patent Application Publication
(10) Pub. No.: US 2005/0044032 A1
(43) Pub. Date: Feb. 24, 2005

(54) Interactive bid evaluation system, method, and iconic interface for combinatorial auctions

(75) Inventors: Ho Soo Lee, Mound Kisco, NY (US); Juhnyoung Lee, Yorktown Heights, NY (US); Jayant R. Kalagnanam, Tarrytown, NY (US); Sudhir Verma, Yorktown Heights, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/645,609

(22) Filed: Aug. 22, 2003

(51) Int. Cl. G06F 17/60

(52) U.S. Cl. 705/37

(57) ABSTRACT

An interactive bid evaluation system (method and storage medium) for a combinatorial auction, includes a display for scaling a plurality of bids and items, on a display window.

### BACKGROUND OF THE INVENTION

1. Field of the Invention

The present invention generally relates to auctions. More specifically, the invention relates to bid evaluation for a specific type of auctions referred to as “combinatorial auctions.” Further, the invention relates to a computer system and a user interface which facilitate bid evaluation for combinatorial auctions.

2. Description of the Related Art

Auctions have been used as a successful way of supporting or even automating negotiations on trading markets. Businesses have been using auction mechanisms for procuring raw materials (e.g., for manufacturing), indirect materials (e.g., office supplies), and services (e.g., for maintenance, repair and operation). Especially, during the past few years, auctions have become popular in conducting trade negotiations on computer networks such as the Internet.

The typical auction process of most auction mechanisms includes steps of bid submission, bid evaluation, and calculation of settlement prices, optionally followed by some feedback to the bidders in an iterative auction. Auctions close either at a fixed point in time or after a certain closing criterion is met (e.g., a certain time elapsed).

In general, auctions are categorized into three different types: forward auctions, reverse auctions, and exchanges.

In a forward auction, one seller receives bids from one or more buyers for one or more products before making a transaction, while in a reverse auction, one buyer receives bids from one or more potential sellers. In an exchange, multiple buyers and multiple sellers submit asks and bids, respectively, to a marketplace which makes matches between the asks and bids either continuously or periodically.

Each of these auction types has many variations depending on the specific rules applied. Some basic examples of forward auctions include “English” (e.g., buyers call ascending prices), “Dutch” (e.g., market manager calls descending prices to obtain buy bids), “Japanese” (e.g., market manager calls ascending prices to obtain buy bids), and “sealed bid” (e.g., buyers place sealed bids).

Forward auctions further include open Request For Bids (e.g., buyers call ascending prices and seller manually selects winners) and sealed Request For Bids (e.g., buyers submit sealed bids and seller manually selects winners).

Some examples of reverse auctions include reverse “English” (e.g., sellers call descending prices), “reverse Dutch” (e.g., market manager calls ascending prices to obtain sell bids), “reverse Japanese” (e.g., market manager calls descending prices to obtain sell bids), and “reverse sealed bid” (e.g., sellers place sealed bids).

Reverse auctions further include open Request For Quotes (e.g., sellers call descending prices and buyer manually selects winners) and sealed Request For Quotes (e.g., sellers submit sealed bids and buyer manually selects winners). Examples of exchanges include continuously clearing exchanges and periodically clearing exchange.

Recently, there are a number of new auction formats developed and used in the “reverse auction” category. These new auction formats allow matching buyer's preferences with seller's bids in a more general sense. They typically allow complex bids such as bundle bids and multi-attribute bids, and, therefore, allow negotiation not only on price but also on quantity and qualitative attributes.

An example of such advanced auction mechanisms is a combinatorial auction, which achieves an efficient trade in situations where bidders are allowed to place bids on combinations of possibly heterogeneous goods or services.

These types of auctions provide a useful negotiation mechanism when there are complementarities or substitutability among several products. In a procurement situation, for example, suppliers can often provide better overall prices, if they are allowed to deliver not just one product type for the buyer (e.g., an office owner), but a bundle of products that complement each other (e.g., computers, monitors, keyboards, and printers).

Explicit consideration of these complementarities in combinatorial reverse auctions can lead to substantial cost savings for buying organizations.

However, a hurdle for the use of combinatorial auctions in practice has been that their bid evaluation is computationally difficult/complex.

The bid evaluation problem for a combinatorial reverse auction is to select a winning set of (bundle) bids such that the demand for each item is satisfied and, at the same time, the total cost of procurement is minimized.

Recent studies on this problem show how the problem can be formulated as a weighted set covering the problem, and solved by using an optimization technique of integer programming. This bid evaluation technique for combinatorial auctions finds an optimal solution, i.e., a set of bids which satisfies the demand for each item and, at the same time, minimizes the total price.

In addition, this technique works with one or more constraints on the auction, such as limiting the minimum and/or maximum number of bids in a solution, and limiting the minimum and/or maximum amount purchased from a particular supplier for one or more specific goods or services. It is noted that a supplier is allowed to submit one or more bundle bids in a combinatorial auction.

One problem with this conventional bid evaluation technique for combinatorial auctions is that it is a “black-box” function that receives an input, i.e., a set of bundle bids and a set of constraints, and generates an optimal solution, i.e., a winning set of bids, but there is no explanation to it.

With no supporting information explaining the solution and constraints satisfied, it is mentally difficult, though not impossible, for a human user to understand how the provided solution minimizes the total purchase price and how it satisfies the demand for each item and all the given constraints.

Such a situation becomes even worse as the number of bids and purchased items increases, and the number and types of constraints increase. The user should just trust the result from the black box function to put it to use. However, the user typically has much uneasiness in just accepting and using the result, without knowing its foundation.

Thus, the conventional bid evaluation technique is a “black-box” function that receives input, i.e., a set of bundle bids and a set of constraints, and generates an optimal solution, i.e., a winning set of bids, but no explanation to it. With little supporting information explaining the solution and constraints satisfied, it is mentally difficult, though not impossible, for a human user to understand how the provided solution minimizes the total purchase price and how it satisfies the demand for each item and all the given constraints. The situation becomes even worse as the number of bids and purchased items increases, and the number and types of constraints increase. The user should just trust the result from the black box function to put it to use.

Additionally, the simple, static, visual display does not scale. That is, when the number of bids and items increases (e.g., over a few tens), and/or the number and types of constraints increase, with this simple display scheme, it is difficult, though not impossible, to display the visual image of the given situation and make it understandable in the limited space such as computer monitors. Also, the conventional display is a static image and does not provide any interactive analysis features.

### SUMMARY OF THE INVENTION

In view of the foregoing and other exemplary problems, drawbacks, and disadvantages of the conventional methods and structures, an exemplary feature of the present invention is to provide a method and system in which a user can use a combinatorial auction technique and can receive an explanation thereof regarding the solution and the constraints satisfied, in an easy manner.

Another exemplary feature is to provide a method and system in which the user can clearly and simply understand how the provided solution minimizes the total purchase price and how it satisfies the demand for each item and all the given constraints.

Yet another exemplary feature is to provide such a method and system for a situation in which there are an increased number of bids and purchased items, and in which there are an increased number and types of constraints increase.

Another exemplary feature of the present invention is an improved bid evaluation system for combinatorial auctions to provide supporting information (e.g., items, bids, constraints, analysis, and results), as well as optimal solutions, that help a user understand and investigate why the solution from the bid evaluation system is optimal and how it satisfies the demand for each item and all the given constraints.

Still another exemplary feature of the present invention is an improved bid evaluation system for combinatorial auctions to provide a user interface that presents solutions and supporting information in an intuitively understandable visual representation, and provides visual operations on graphical entities of the visual representation.

Yet another exemplary feature of the present invention is an improved bid evaluation system and user interface for combinatorial auctions to enable a user to interactively generate ad hoc solutions by using visual operations, for comparing them with the machine-generated optimal solution. By comparing ad hoc solutions and the machine-generated solution, the user can understand how the optimal solution is better than ad hoc ones, and what are the factors that affected the result.

Still another exemplary feature of the present invention is an improved bid evaluation system and user interface for combinatorial auctions to enable a user to dynamically update auction parameters (e.g., including items in it, bundle bids under consideration, and constraints) and generate (e.g., both ad hoc and optimal) solutions iteratively for a what-if analysis. Going through various what-if scenarios, the user can understand factors that affect the auction result, and reformulate the auction with a different parameter setting to save cost and/or satisfy other possible conditions.

Yet another exemplary feature of the present invention is an improved bid evaluation system and user interface for combinatorial auctions to enable a user to generate an optimal solution for an auction after pre-assigning one or more bundle bids to the winning bid pool.

Still another exemplary feature of the present invention is an improved bid evaluation system and user interface for combinatorial auctions to provide one or more recommendations on what actions to take next in generating ad hoc solution and enable the user to enforce one or more recommendations by using a pointing device such as computer mouse.

In a first exemplary aspect of the present invention, an interactive bid evaluation system (method, storage medium, and method for deploying computing infrastructure in which computer-readable code is integrated into a computing system, such that the code and the computing system combine to perform the method) for a combinatorial auction, includes a display for scaling a plurality of bids and items, on a display window.

In a second exemplary aspect of the present invention, a method (storage medium, and method for deploying computing infrastructure in which computer-readable code is integrated into a computing system, such that the code and the computing system combine to perform the method) of evaluating bids in a combinatorial auction, includes structuring bid and item information on a visual interface of a display; and providing an analysis capability for facilitating evaluation and selection of at least one solution encompassing bids. The visual interface allows a user to directly manipulate data points in the visual interface to explore an information space of potential solutions and suppliers and to discover at least one solution optimal to the user's needs.

With the unique and unobvious aspects and features of the present invention, the user can clearly and simply understand how the provided solution minimizes the total purchase price and how it satisfies the demand for each item and all the given constraints, even when there are an increased number of bids and purchased items, and when there are an increased number and types of constraints.

Additionally, supporting information (e.g., items, bids, constraints, analysis, and results) can be provided, as well as optimal solutions, that help a user understand and investigate why the solution from the bid evaluation system is optimal and how it satisfies the demand for each item and all the given constraints.

Further, the user interface according to the invention presents solutions and supporting information in an intuitively understandable visual representation, and provides visual operations on graphical entities of the visual representation.

Moreover, the user can interactively generate ad hoc solutions by using visual operations, for comparing them with the machine-generated optimal solution. By comparing ad hoc solutions and the machine-generated solution, the user can understand how the optimal solution is better than ad hoc ones, and what are the factors that affected the result.

Additionally, the user interface can enable a user to dynamically update auction parameters (e.g., including items in it, bundle bids under consideration, and constraints) and generate (e.g., both ad hoc and optimal) solutions iteratively for a what-if analysis. Going through various what-if scenarios, the user can understand factors that affect the auction result, and reformulate the auction with a different parameter setting to save cost and/or satisfy other possible conditions.

Finally, with the present invention, a user can generate an optimal solution for an auction after pre-assigning one or more bundle bids to the winning bid pool, and the user interface can provide one or more recommendations on what actions to take next in generating ad hoc solution and enable the user to enforce one or more recommendations by using a pointing device such as computer mouse.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a conventional iterative auction process flow 100;

FIG. 2 illustrates an exemplary conventional combinatorial reverse auction 200;

FIG. 3 illustrates an exemplary conventional calculation 300 of an optimal solution for a combinatorial auction;

FIG. 4 illustrates a block diagram of a preferred iconic user interface 400;

FIG. 5 illustrates a block diagram of a preferred system architecture 500;

FIG. 6 illustrates a conventional visual representation 600 of a combinatorial auction;

FIG. 7 illustrates a visual representation 700 of a combinatorial auction according to the present invention;

FIG. 8 illustrates an analysis view 800 according to the present invention;

FIG. 9 illustrates interactively creating an ad hoc solution 900 in the analysis view according to the present invention;

FIG. 10 illustrates adding and deleting items 1000 in the analysis view according to the present invention;

FIG. 11 illustrates adding and deleting bids 1100 in the analysis view according to the present invention;

FIG. 12 illustrates a constraint window 1200 according to the present invention;

FIG. 13 illustrates a visual representation 1300 of solutions in a result view according to the present invention;

FIG. 14 illustrates adding and deleting attributes 1400 in the analysis 10 view according to the present invention;

FIG. 15 illustrates an exemplary hardware/information handling system 1500 for incorporating the present invention therein; and

FIG. 16 illustrates a signal bearing medium 1600 (e.g., storage medium) for storing steps of a program of a method according to the present invention.

### DETAILED DESCRIPTION OF EXEMPLARY EMBODIMENTS OF THE INVENTION

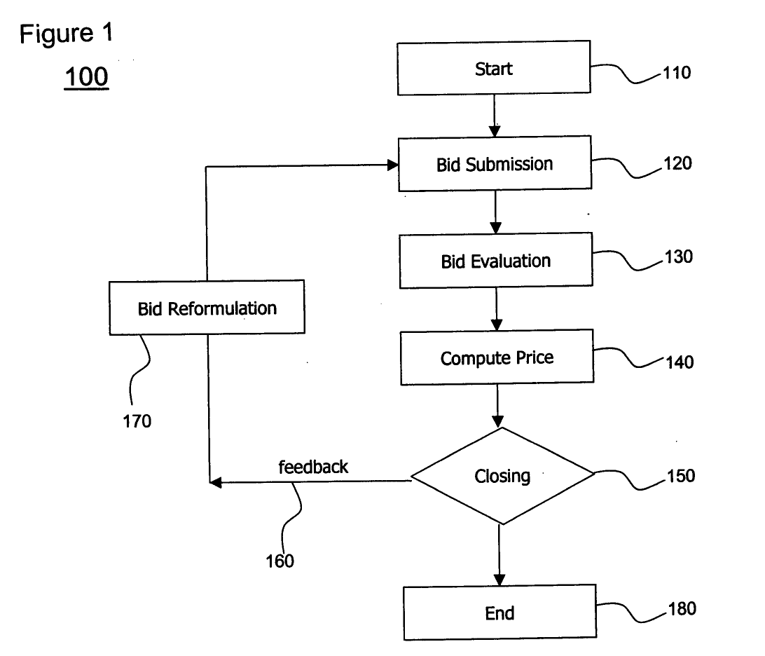

Referring now to the drawings, and more particularly to FIGS. 1-6, there are shown exemplary embodiments of the method and structures according to the present invention.

### Exemplary Embodiment

FIG. 1 illustrates a conventional iterative auction process flow 100 including steps of bid submission (120), bid evaluation (130), and calculation of settlement prices (140), probably (optionally) followed by some feedback (160) to the bidders.

Based on the feedback (160), a bidder may reformulate (170) and resubmit (120) his/her bid for the next round of bid evaluation (130).

Auctions close (150) either at a fixed point in time, or after a certain closing criterion is met (e.g., a certain time elapsed).

In a reverse auction, sellers of goods or providers of services, as bidders, submit bids, while a buyer evaluates the submitted bids and computes the winning prices.

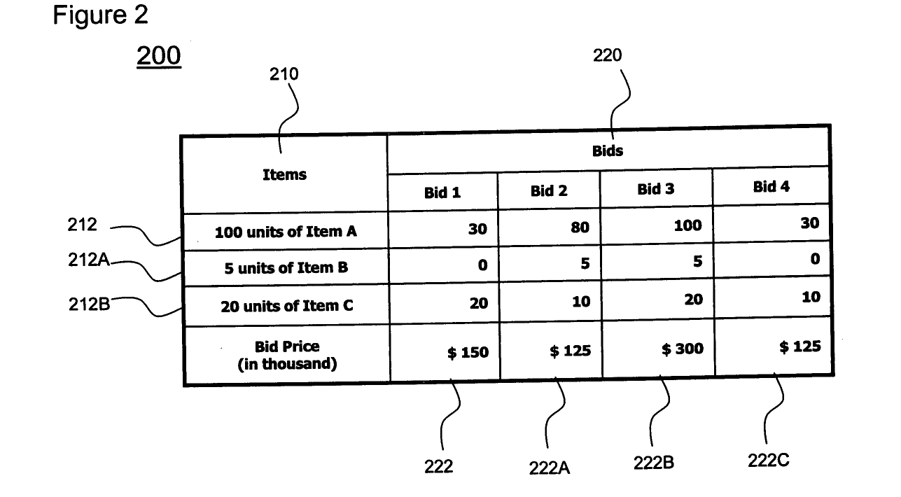

FIG. 2 illustrates a conventional combinatorial reverse auction 200, which achieves an efficient trade, in situations where bidders are allowed to place bids on combinations of possibly heterogeneous goods or services.

A first column 210 of the table shown in FIG. 2 presents the demand of this buyer, a combination of three different items including Item A (212), Item B (212A), and Item C (212B), and the amount demanded for each item (e.g., 100, 5, and 20 units), respectively.

The second column 220 presents four bundle bids submitted against this demand (210), Bid 1 (222), Bid 2 (222A), Bid 3 (222B), and Bid 4 (222C). Each bid specifies a bundle of items and the amount of each item in the bundle the bid offers. Each bid makes this bundle offer with a bundle price, $150, $125, $300, and $125, respectively. In the conduct of combinatorial reverse auctions, bidders provide a discounted price on a bundle of items for various reasons (e.g., they might have excess inventory in a local warehouse or spare capacity in the carrier and hence can reduce transportation costs, etc.). However, the discounted bid price is valid only if the entire bid is accepted.

After a buyer creates a combinatorial reverse auction and receives one or more bundle bids from bidders (i.e., sellers), the buyer is now faced with the task of reviewing the information of each bundle bid and deciding which bids to accept. In FIG. 1, this task is referred to as the “bid evaluation” 130, and its objective is to select one or more submitted bundle bids such that the demand for each item is satisfied and, at the same time, the total cost of procurement is minimized. The conventional techniques formulate this problem as a weighted set covering problem which is solved by using an optimization technique of integer programming.

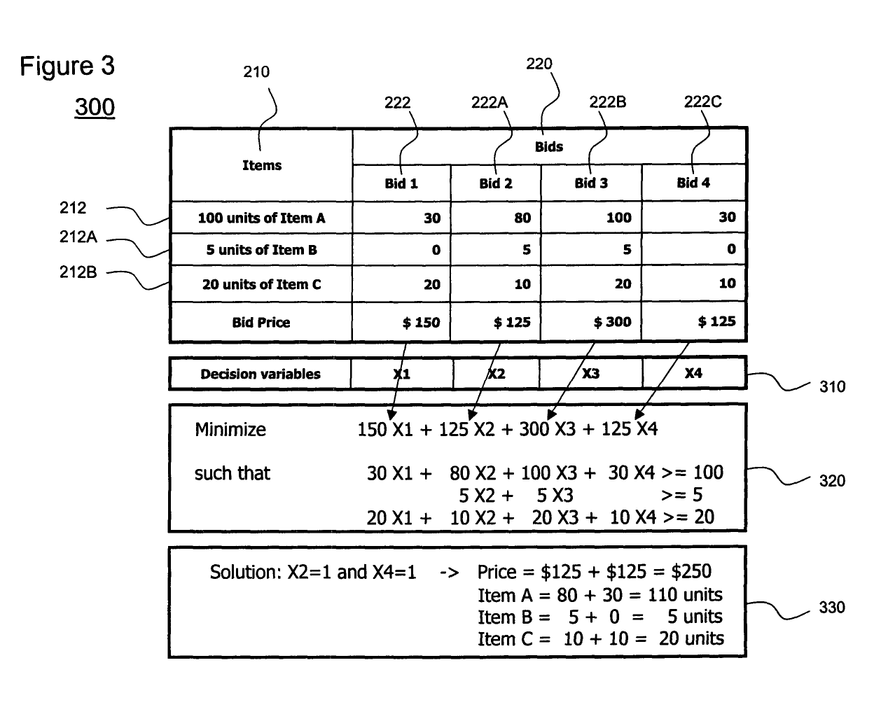

FIG. 3 illustrates a method 300 of formulation and calculation of an optimal solution of an example bid evaluation problem for a combinatorial auction.

In the given example combinatorial reverse auction 200, each bidder has provided a bundled “all-or-nothing” bid and a price for the bundle. To formulate an optimization problem that can be solved optimally, a set of decision variables (310), X1, X2, X3 and X4 (one set for each bid) is introduced.

The problem formulation 320 attempts to minimize total purchasing price while ensuring that the demand for each item is satisfied. This optimization problem can be solved by using a software package such as IBM OSL which provides various algorithms for solving optimization problems. The solution 330 for this example problem is presented.

It is noted that the optimal supply may over-satisfy demand, as is the case in this example for Item A (e.g., the minimum price solution generates a supply of 10 units more than the demanded amount, 100 units). If there is no holding cost, then this may be acceptable or even desirable.

The complexity of finding the winning bid set in general is a computationally difficult problem, as the number of bids becomes large. It is noted that, in general, each bidder is allowed to submit more than one bid and as the number of items increases, the number of bids can become quite large. It is further noted that this optimization technique works with one or more constraints on the auction, such as limiting the minimum and/or maximum number of bids in a solution, and limiting the minimum and/or maximum amount purchased from a particular supplier for one or more specific goods or services.

One problem with the conventional bid evaluation technique for combinatorial auctions is that it is a “black-box” function that receives input, (i.e., a set of bundle bids and a set of constraints), and generates an optimal solution (i.e., a winning set of bids), but there is no explanation which goes with the solution.

With no supporting materials explaining the solution and constraints satisfied, it is mentally difficult (though not impossible), for a human user to understand how the provided solution minimizes the total purchase price and how it satisfies the demand for each item and all the given constraints. The situation becomes even worse as the number of bids and purchased items increases, and the number and types of constraints increase. Hence, with the conventional technique, the user is expected to merely trust the result from the black box function to put it to use.

An exemplary feature of the present invention is to improve the conventional bid evaluation system for combinatorial auctions by providing a system and user interface which displays information on items, bids, constraints, analysis, and results in relation to the generated optimal solution, to help a user understand and confirm how the optimal solution minimizes the total purchase price and how it satisfies the demand for each item and all the given constraints.

Additionally, the system and user interface enables a user to interactively generate ad hoc solutions by using visual operations, for comparing them with the machine-generated optimal solution. By comparing ad hoc solutions and the machine-generated solution, the user can understand how the optimal solution is better than ad hoc ones, and what are the factors that affected the result.

Additionally, the system and user interface enables a user to dynamically update auction parameters (e.g., including items in it, bundle bids under consideration, and constraints) and generate (e.g., both ad hoc and optimal) solutions iteratively for a what-if analysis. By going through various what-if scenarios, the user can understand factors that affect the auction result, and reformulate the auction with a different parameter setting to save costs and/or satisfy other possible conditions.

The system and user interface of the present invention is not necessarily a substitute for the quantitative analysis of the conventional optimization technique. Rather, it provides a qualitative means for focusing exploratory analysis, and helping users select the most appropriate parameters for the quantitative technique.

Further, the system and user interface enables a user to generate an optimal solution for an auction after pre-assigning one or more bundle bids to the winning bid pool.

Further, the system and user interface provides a user with one or more recommendations on what actions to take next in generating ad hoc solution.

Additionally, it is noted that each item in the demand may have different attributes. However, in contrast to the conventional optimization-based solution techniques, in the present invention, the attributes are not necessarily assumed to be equal.

That is, the invention can consider attributes of each type of bid, each type of item, each type of supplier, etc. (and assign values thereto). As a result, the visual interface of the invention allows the user to create different types of potential solutions (using different attribute values and other considerations that are not taken into account in conventional optimization techniques), and can compare them to one another, to find the optimized solution.

Further, in the conventional technique, there is no scalability of the conventional interface. Thus, if there are many items and many bids, it is difficult for the user to view all of the items, bids, etc., thereby making it difficult for the user to understand. In contrast, the present invention can scale the interface, thereby making it easy for the user to understand. Indeed, as discussed below, for each item, etc., the invention uses a relative scale, thereby making the solution easy to view.

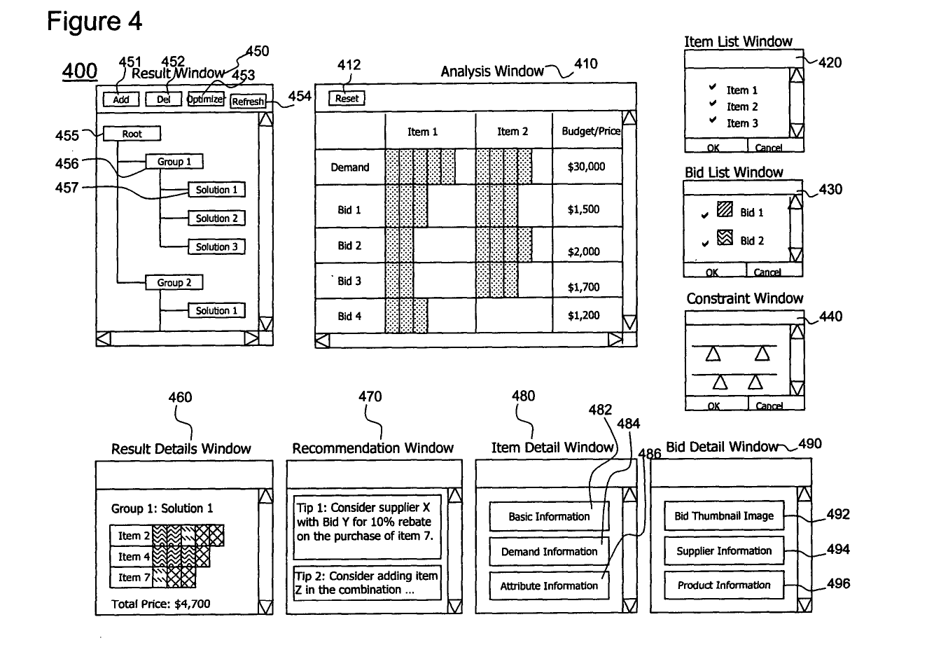

FIG. 4 is a block diagram of a preferred iconic user interface 400 showing the Analysis Window 410, the Item List Window 420, the Bid List Window 430, the Constraint Window 440, the Result Window 450, the Result Detail Window 460, the Recommendation Window 460, the Item Detail Window 480, and the Bid Detail Window 490.

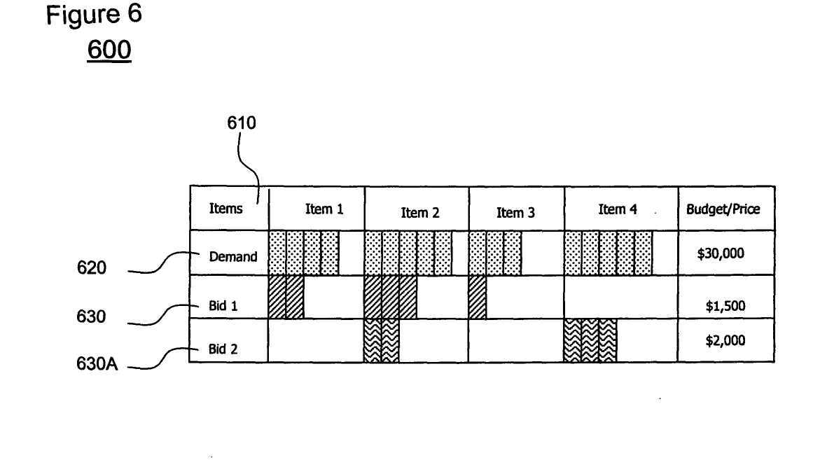

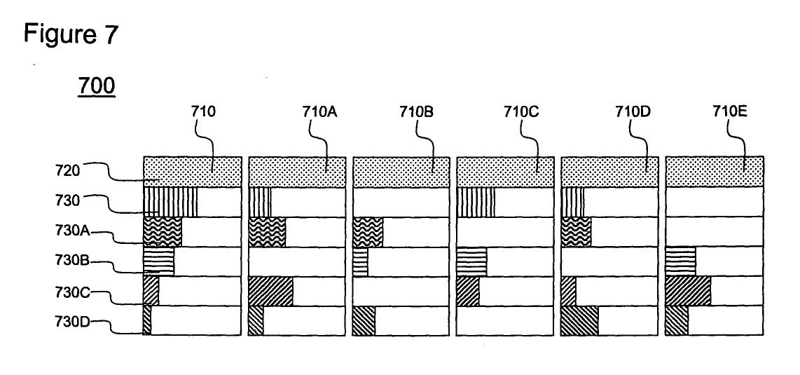

The Analysis Window 410 displays a combinatorial reverse auction comprising a bundle demand (i.e., a combination of items and the demanded amount for each item), and a set of submitted bundle bids. The auction may be presented in many different forms (e.g., in a table or by graphical presentation). FIGS. 6-8 depict and describe different graphical representations of combinatorial auctions. Also, FIGS. 7-9 describe several visual operations for exploring different aspects of combinatorial auctions and generating ad hoc solutions.

The Reset button 412 is used to clear up visual changes to the graphical representation made by using the visual operations and display the initial view of the combinatorial auction.

The Item List Window 420 displays a list of all the items the user (i.e., buyer) hopes to procure and the demanded amount for each item. Also, the Item List Window 420 allows the user to select or de-select one or more items that the user wants to include or exclude, respectively, in the Analysis Window 410. This capability for dynamic item selection is useful for running what-if scenarios in the Analysis Window 410.

As the bundle demand in the Analysis Window 410 is updated by the user's item selection operation in the Item List Window 420, the set of bundle bids displayed in the Analysis Window 410 is also updated. A bundle bid whose combination of items includes one that is not selected in the Item List Window 420 is not displayed in the Analysis Window 410.

Associated with the Item List Window 420 is the Item Detail Window 480 which can be opened from the Item List Window 420 by using an operation of a pointing device such as computer mouse, joystick, pointer, etc.

The Item Detail Window 480 can be used to display various information about a particular item, including the Basic information 482 such as item name and SKU (Stock Keeping Unit) number, the Demand information 484 such as the total demanded amount and demanded amount for different departments, and the Attribute information 486 such as size, color, power, etc. In addition, other information related to making purchase decisions, such as information about the suppliers of this item until now, can be presented.

Thus, for example, if the user (buyer) has a long-term relationship with a particular supplier, then such detailed information can be noted here in these secondary windows (e.g., details windows) such as the Item Detail Window 480, shown in the bottom portion of FIG. 4.

The Bid List Window 430 displays a list of all the submitted bundle bids (along with their bundle price). Also, the Bid List Window 430 allows the user to select or de-select one or more bids that the user wants to include or exclude, respectively, in the Analysis Window 410. This capability for dynamic bid selection is useful for running what-if scenarios in the Analysis Window 410.

Associated with the Bid List Window 430 is the Bid Detail Window 490 which can be opened from the Bid List Window 420 by using an operation of a pointing device such as computer mouse, etc. The Bid Detail Window 490 can be used to display various information about a particular bid, including the Bid thumbnail image 492 (i.e., a graphical representation of the bid), the Supplier information 494 such as the supplier name, performance rating, reputation, strategic fit, relationship duration, etc., and the Product information 496, (i.e., detailed information of items, products, or services) bundled in this bid. In addition, this window can display other information related to making purchase decisions, for example, how this bid has been revised through multiple rounds of the iterative auction process 100.

The Constraint Window 440 displays a list of all the constraints applicable to the current auction setting presented in the Analysis Window 410. Also, the Constraint Window 440 enables the user to dynamically update the values of constraints and apply them to the bid evaluation in the Analysis Window 410.

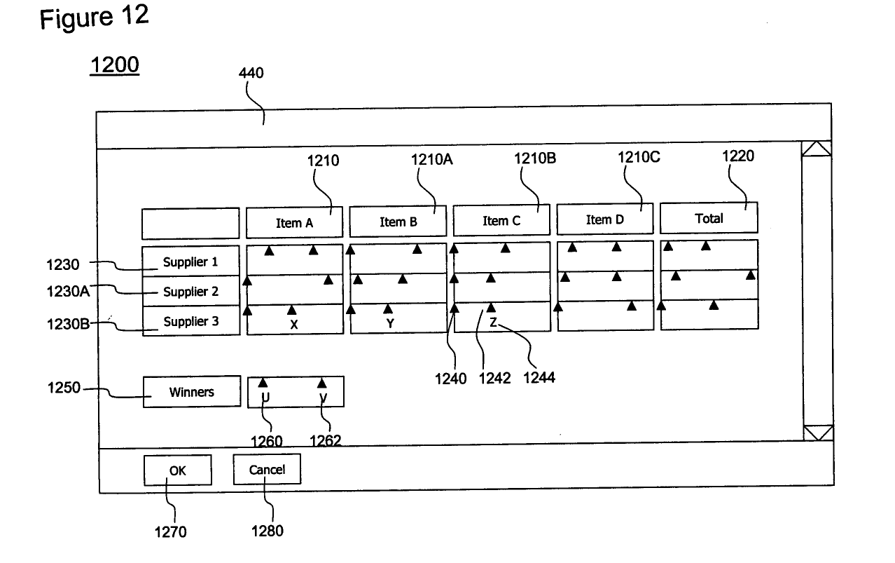

Examples of constraints that can be set for a combinatorial reverse auction include limiting the minimum number of winning suppliers in a solution (e.g., to avoid dependency on too few suppliers), limiting the maximum number of winning suppliers in a solution (e.g., to avoid high transaction and overhead costs), limiting the minimum and/or maximum amount purchased from a particular supplier for a specific item, and limiting the minimum and/or maximum amount purchased from a particular supplier in total. The detail graphical representation of the Constraints Window 440 is provided in FIG. 12.

The Result Window 450 groups and displays in a hierarchical tree structure (optimal and ad hoc) solutions for various combinatorial auction bid evaluation problems set up in the Analysis Window 410. Under the root 455 of the tree structure, there can be one or more analysis groups 456. Each group represents a bid evaluation problem for a particular combinatorial auction setting displayed in the Analysis Window 410. Thus, different solutions can be classified in an easily-navigable format in a hierarchical way in the Result Window 450. Each group represents a different demand created by the user. Thus, for each group, there may be one or more solution, including the one from an optimizer.

As explained above, the user can create a new bid evaluation problem by changing the values in the Item List Window 420, the Bid List Window 430, and the Constraint Window 440. Once a bid evaluation problem is determined in the Analysis Window 410, then it can added to the Result Window 450 as a group 456 by using the Add button 451. If necessary, a group can be deleted from the Result Window 450 by using the Delete button 452.

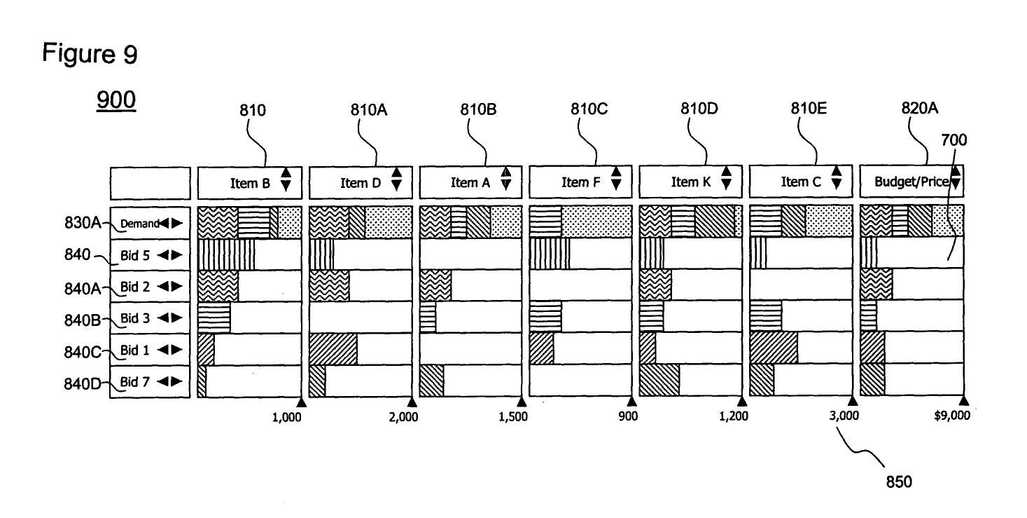

For a bid evaluation problem, a user can generate an optimal solution by using the Allocation Optimizer 580, the conventual optimization technique 300 described in FIG. 3. A user can invoke the Allocation Optimizer 451 by using the Optimizer button 453 in the Result Window 450. In addition, the user can interactively generate one or more ad hoc solutions directly in the Analysis Window 410 by using visual operations which are described in detail in association with the description below of FIG. 9.

Generated solutions (either optimal or ad hoc) can be added to solution slots 457 in the Result Window 450. If necessary, a solution 457 in the Result Window 450 can be deleted by using the Delete button 452.

Associated with the Result Window 450 is the Result Detail Window 460 which can be opened from the Result Window 450 by using an operation of a pointing device such as computer mouse, pointer, trackball, joystick, etc. While the Result Window 450 displays only image thumbnails of solutions and brief text information, the Result Detail Window 460 presents various detailed information on a particular solution 457, such as a full-sized image of the bundle demand and a combination of one or more bundle bids that make up a solution with detailed text.

Thus, when one combinatorial auction demand is created, one or more potential solutions can be created, including the solution created by the optimization technique. The result details window 460 shows one particular such solution for one particular demand in a separate window. As shown, the solution includes different amounts of bids for each item, with the bids from different suppliers being shown in different patterns.

The Recommendation Window 470 provides one or more hints (advice/suggestions) for each step in generating an ad hoc solution for a combinatorial auction bid evaluation problem.

The Allocation Recommender engine 590 analyzes the detailed information of items and submitted bundle bids, and generates one or more recommendations for each step of ad hoc solution generation.

The Recommendation Window 470 presents the generated hints, and a user can directly enforce the recommendation in the Recommendation Window 470 by using an operation of a pointing device such as computer mouse, etc.

For example, the Recommender 590 may suggest adding to a solution a bid from a particular supplier who provides a large rebate on a certain condition. Such information is not taken into account when finding an optimal solution by using the prior art optimization technique. Also, the Recommender 590 can make a suggestion of a particular bid based on constraints set in the Constraint Window 440, as will be explained in FIG. 12.

With this window 470, the user can obtain real-time information (e.g., through instant messaging, e-mail type information, etc.) And can find the latest information about the bid, the supplier, etc. Thus, if a supplier has recently decided to run a promotion on a particular item, such information can be immediately notified of the same. Hence, assume that the supplier submitted a bid two (2) hours ago, but has only started to run a promotion in the last several minutes. When the buyer starts the analysis of the bids, then the promotion information can be immediately provided to the buyer via the recommendation window 470, and the buyer can take such information into account and create an ad hoc solution.

Another feature of the invention is that when evaluating a demand and submitted bid, a premium supplier may exist (may have placed a bid). With the invention, when this premium supplier makes a bid, this premium supplier may be automatically selected. Thus, the user may in advance decide that when the user is evaluating the submitted bids, the user can set aside the submitted bid of such premium suppliers. By doing so, the user must subtract the amounts of the items which the premium supplier is going to provide automatically, and the bid must be changed. That is, the bid is changed (e.g., amount, items, etc.) because the user has preassigned a portion of the demand to the premium supplier. Such an operation can be easily performed by using the bid list window 430, and actually checking (or unchecking) the bids from the premium suppliers, so that the demand (and submitted bid) automatically changes.

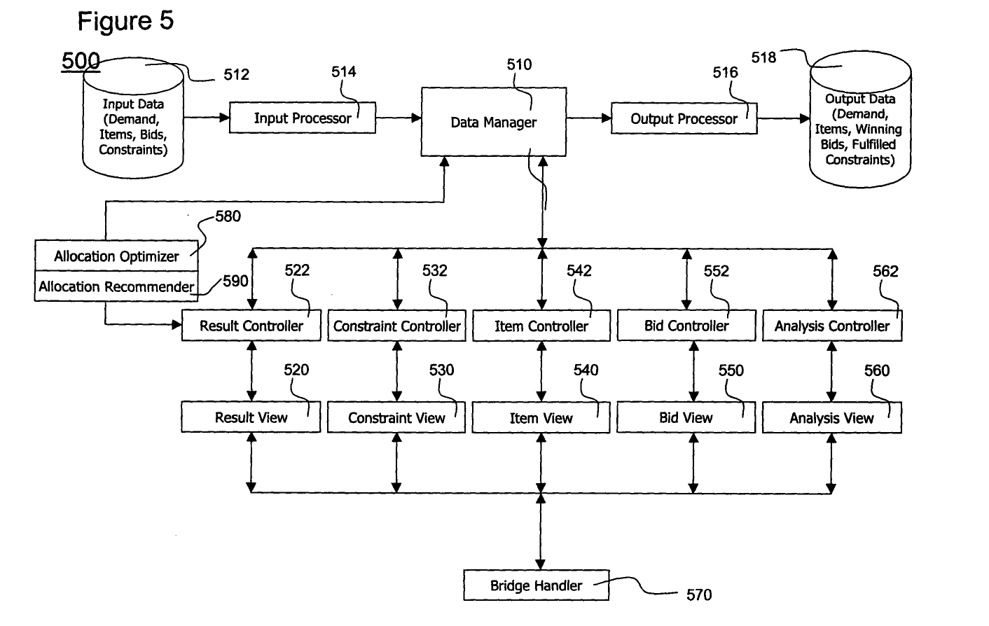

FIG. 5 is a block diagram of a preferred system architecture 500 showing the Data Manager 510, Input Database 512 and Output Database 518, Input Data Processor 514 and Output Data Processor 516, several Views 520, 530, 540, 550 and 560 and Controller processes 522, 532, 542, 552 and 562 for different Windows 410, 420, 430, 440, 450, 460, 470, 480 and 490, the Bridge Handler 570, the Allocation Optimizer 580, and the Allocation Recommender 590.

The Data Manager 510 is a process that stores the initial data set (including a bundle demand, a set of submitted bundle bids and associated constraints for a combinatorial reverse auction), and a snapshot data set updated by visual operations on the Analysis Window 410, the Item List Window 420, the Bid List Window 430, the Constraint Window 440, and the Result Window 450. Thus, for each Window of FIG. 4, there is an architecture box for such a View.

Hence, the snapshot data set provides the view currently rendered in the Analysis Window 410, the Item List Window 420, the Bid List Window 430, the Constraint Window 440, and the Result Window 450. A user can refresh the views with the initial data set in the Analysis Window 410, the Item List Window 420, the Bid List Window 430, and the Constraint Window 440 by using the Reset button 412 on the Analysis Window 410.

The Input Database 512 provides the initial data set that includes a bundle demand, a set of submitted bundle bids and associated constraints for a combinatorial reverse auction. The initial data set is collected in the first two steps (110 and 120) of the iterative auction process flow 100. The Input Data Processor 514 stores the initial data set in the Data Manager 510. This task often involves a mapping between the data structure (also known as data schema of the Input Database 512) and the data structure of the Data Manager 510.

When the bid evaluation of a combinatorial auction is completed, the snapshot data set in the Data Manager 510 contains one or more solutions (each including a set of winning bids and fulfilled constraints along with the bundle demand). The Output Processor 516 retrieves the solution data out of the Data Manager 510 and stores it in the Output Database 518. The users can access the solution data in the Output Database 518 to process orders, and/or for reporting or analysis purposes.

Each Window (410, 420, 430, 440, 450, 460, 470, 480 and 490) in the block diagram of preferred iconic user interface 400 is associated with a view (520, 530, 540, 550 and 560) and a controller (522, 532, 542 552 and 562) in this preferred system architecture 500.

These windows share the common set of data (e.g., both the initial data set and snapshot data sets) of the Data Manager 510. The view of each window is the visual rendering of a selected data set for this window. The controller of each window manages its view and handles visual operations provided in its view. To reflect the changes caused by the visual operation in the view, the controller updates the snapshot data in the Data Manager 510.

The Bridge Handler process 570 synchronizes the status among different views, and thus the bridge handler 570 coordinates the various views. For example, if an item is de-selected in the Item List Window 420 and its view is updated accordingly (e.g., the item is removed in the view), then the Bridge Handler 570 recognizes this change, and notifies it to the controller 562 of the Analysis Window 410, so that the controller can update the view 560 to reflect the update in the Item List Window 420.

The Allocation Optimizer process 580 is invoked when the Optimizer button 453 is clicked on in the Result Window 450. Once a combinatorial auction is formed by a setting in the Analysis Window 410, this Allocation Optimizer 580 is invoked to find the optimal solution for the auction. The Allocation Optimizer 580 implements the prior art optimization technique described in detail in FIG. 3.

The Allocation Recommendation process 590 analyzes the initial data set and snapshot data sets stored in the Data Manager 510, and generates one or more recommended actions to take for each step of ad hoc solution generation.

The recommended actions are displayed in the Recommendation Window 470, and a user can directly enforce the recommendation in the Recommendation Window 470 by using an operation of a pointing device such as computer mouse, etc. The result is reflected in the Analysis Window 410 and/or the Result Window 450.

FIG. 6 illustrates a conventional visual representation 600 of a combinatorial auction showing items 610, a bundle demand with its budget (e.g., the budget of the demand is optional information.) 620, and two bundle bids with their price (630 and 630A).

While the table representation of a combinatorial auction in FIG. 2 specifies the amount of each item in the bundle demand and bids 220 in text, this visual representation specifies the amount of each item in the demand 620 and bids (630 and 630A) with glyphs called “tile.” Each tile represents a unit amount of an item. Therefore, a bundle demand or a bundle bid is represented by a collection of zero or more tiles for each item considered in the combinatorial auction.

This visual representation of bundle demands and bids helps users quickly understand how much is required/offered in the demand/bids for each item and compare different bids intuitively.

However, it is noted that in this conventional representation of FIG. 6, that the amount is rendered in absolute terms. Thus, the amounts in the conventional rendering do not scale.

Hence, for example, if the demand for a particular item is 100 units, in the limited space of a computer monitor (display), it would be difficult to represent all 100 units (tiles). Thus, the conventional display would not scale (e.g., make the tiles smaller) to display all 100 units on the same screen, but instead, the display would keep the tiles the same size and display only a predetermined portion of the 100 (e.g., possibly only 50 of them or some other number less than the entirety). Thus, the demand could not be rendered for the user to easily view the demand.

Additionally, if the conventional representation displayed different levels of unit items (e.g., a unit item of 1 ton, or a unit item of 100 tons), it may be possible to scale to a small degree, but to deal with different levels of the unit items is confusing.

Thus, in the conventional representation there is a scalability problem (or more specifically a lack thereof) and since there are many items and the amount of each item is large, it is extremely difficult in the conventional techniques to render them in an effective way on a computer monitor (display). For the user, it is very difficult to understand and explore (navigate) the visualization.

FIG. 7 is a visual representation 700 according to the present invention of a combinatorial auction based on “band” glyphs, as compared to the conventional visualization of FIG. 6 which is based on “tiles.” An important feature of the visualization of FIG. 7 is that it can scale. That is, for each item, relative scale is used.

The visual representation comprises one of more vertical blocks (710, 710A, 710B, 710C, 710D and 710E) comprising one or more (e.g., preferably color or pattern-coded) strips. Each of these blocks represents an item under consideration in this particular combinatorial auction. The blocks are called “item blocks.” From another perspective, the visual representation comprises one or more horizontal bands, each of which represents a bundle demand 720 or a bundle bid (730, 730A, 730B, 730C and 730D). These bands are called the “demand band” 720 and “bid bands,” respectively.

The first strip in an “item block” represents the demanded amount for this item, and is called a “demand strip.” Below this demand strip in an item block, there are one or more color or pattern-coded strips that represent the bid amount of bundle bids for this item. These strips are called “bid strips.” The bid strips preferably are color or pattern-coded by bidder. The “demand band” comprises one or more “demand strips” for individual items. Similarly, a “bid band” comprises one or more “bid strips” for individual items.

It is noted that the demand strips of different items blocks (710, 710A, 710B, 710C, 710D and 710E) are of the same size. The amount of each bid for an item is represented by the size of the bid strip relative to the size of the demand strip. This means that each item block has its own scale. This idea significantly simplifies the visualization when compared to the conventional tile-based visualization in FIG. 600.

The absolute amount of a bid for an item can be presented in this visualization in many different ways (e.g., by using text embedded in the visualization, or presenting the text (of the absolute amount) in a small tool-tip window or a “pop-up window” by using an operation with a pointing device such as a computer mouse, a launch pad, etc.).

The pop-up window is launched if, for example, the cursor rests on the area of interest. As a result, the cartoon/cloud with brief information is displayed. In contrast, if the area of interest is clicked on an item detail window will be launched having detailed information for the user to view. Thus, all of the information available in the conventional technique is still provided by the present invention, but the present invention allows a scaling of items, etc. which enable the user to easily view and understand solutions.

The simplified visual representation of a combinatorial auction by using a “demand band” and one or more “bid bands” scales well.

That is, the visual representation works well even when the number of items and bundle bids in an auction becomes large. The conventional visualization shown in FIG. 6 does not scale well. Indeed, it creates information clutter and does not help human perception well, as the number of items and bundle bids in an auction become large.

Another advantage of using the band-based visual representation is that a user can easily superimpose one or more “bid bands” on the “demand band,” to compare the bids and also to create one or more ad hoc solutions, as will be described further in FIG. 9.

The actual superimpose operation can be implemented as a “drag-and-drop” operation on a computer graphical user interface such as Microsoft Windows® operating system, by using a pointing device such as a computer mouse or a launch pad.

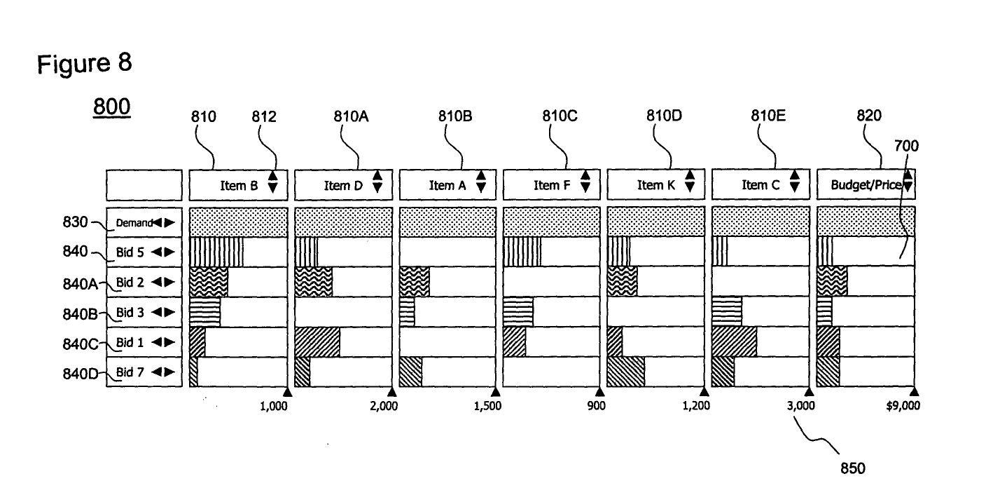

FIG. 8 illustrates an analysis view showing the visual representation of a combinatorial auction 700 augmented by a number of ancillary information and operations including item headers (810, 810A, 810B, 810C, 810D and 810E), a budget/price block 820, a demand header 830, bid headers (840, 840A, 840B, 840C and 840D), and embedded text of the demanded amount for each item and the budget 850.

The item headers (810, 810A, 810B, 810C, 810D and 810E) anchor the “item blocks” displaying the item name.

In addition, an item header provides a set of sorting button 812. By using these buttons, a user can sort (e.g., in either an ascending or a descending order) the displayed bundle bids by amount for the item. The bid bands are reordered by the sorting result. This provides the user with an efficient method for understanding how bids are distributed for an item basis.

The budget/price block 820 is added to provide a visual representation of the budget of the demand and the prices of the bundle bids. Its representation is similar to that of the item blocks. The “budget” is the budget that the buyer has for the specified demand, and the “price” is the price for each bid. That is, the budget is represented by the first strip in the block, and the price of each bid is represented by the size of the “price strip” relative to the size of the “budget strip.”

The demand header 830 and the bid headers (840, 840A, 840B, 840C and 840D) anchor the “demand band” and the “bid bands,” respectively, displaying their names. Similarly with item headers, the demand header and the bid headers provide buttons for sorting. By using these buttons, a user can sort (e.g., in either an ascending or a descending order) the strips in the demand or a bundle bid by amount (e.g., in either absolute or relative terms). The item blocks will be reordered by the sorting result.

The embedded text 850 displays the demanded amount for each item and the budget. In a similar way, the text for the offered amount for each item and the price of a bid can be embedded in the visual representation. Alternatively, this text information along with other detailed information on the demand and the bundle bids can be displayed on demand on a tool-tip window or a pop-up window by using a pointing operation with a pointing device such as a computer mouse or a launch pad.

It is noted that the numbers at the bottom of the analysis view of FIG. 8 represent the budget for each item. Thus, for example, the budget for item B would be $1,000, the budget for item D would be $2,000, and so forth. The total budget is $9,000, as shown in the far right block of FIG. 8.

FIG. 9 illustrates interactively creating an ad hoc solution 900 in the analysis view by superimposing one or more “bid bands” on the “demand band.”

As described earlier, the superimpose operation can be implemented as a “drag-and-drop” operation on a computer graphical user interface (GUI) such as Microsoft Windows® operating system, by using a pointing device such as a computer mouse or a launch pad.

The demand band 830A now represents an ad hoc solution being created. Looking at the demand band, the user can tell which bundle bids are added to the ad hoc solution by the color or pattern code of the strips. In this example, three bundle bids including Bid 2 (840A), Bid 3 (840B), and Bid 7 (840D) were added to the ad hoc solution. It is noted that, for Bid 3 for Item D, no amount was bid, and thus the ad hoc solution only has an amount for Item in Bid 2 and Bid 7.

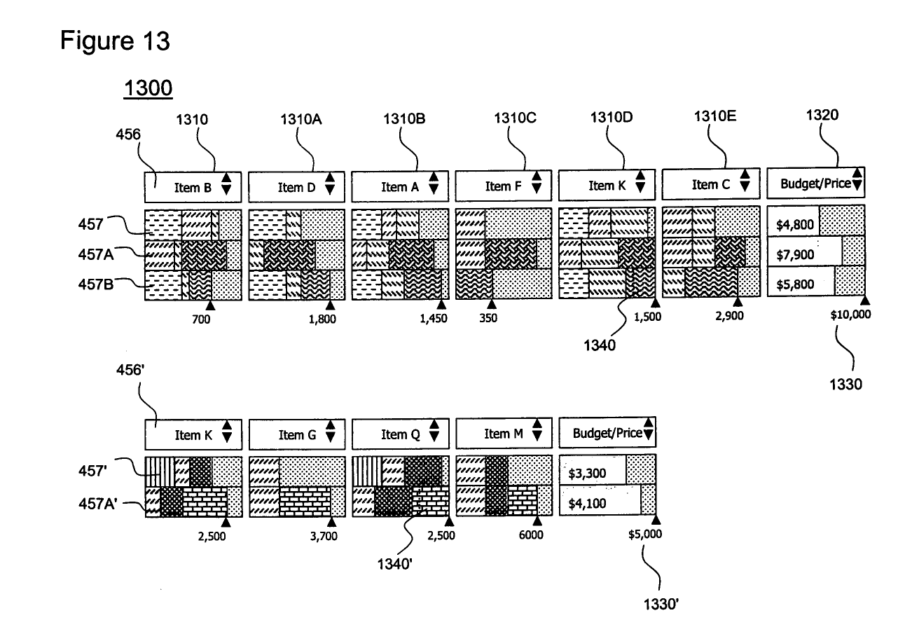

It is noted that the aggregated price for the ad hoc solution is calculated and visualized on the fly in the demand band. Once an ad hoc solution is created by using simple drag-and-drop operations in the Analysis Window 410, then it can be added to the Result Window 450 by using the Add button 451. A user can interactively create one or more ad hoc solutions in this way, and compare them in the Result Window 450, as described below with regard to FIG. 13.

Hence, by using simple drag and drop operations, the user can easily create ad hoc solutions, and can easily see how much of the amount is fulfilled with the current solution (in which bid(s) may be added, removed, manipulated, etc.). Such a simple operation was not possible in conventional optimization-based solutions, in which, as discussed above with regard to FIG. 1, the entire bid would have to be reformulated by adjusting/changing the mathematical formulation again, changing the bid again, running the optimization engine, and then obtaining and reviewing the solution.

It is noted that an optimization solution can be created and added to the Result Window 450 by using the Optimizer button 453 and the Allocation Optimizer engine 580, as explained earlier. The optimal solution can be visually compared with one or more ad hoc solutions in the Result Window 450 and also examined in detail in the Result Detail Window 460. Also, the optimal solution can be visually represented in the demand band 830A of the Analysis Window 410.

In addition to the pure ad hoc solutions and the pure optimal solution explained above, the system and user interface of this invention allows the user to generate one or more solutions of a hybrid form as discussed below.

In the Analysis Window 410, a user creates a combinatorial auction by setting the items, bids, and constraints under consideration. Then, the user generates a partial ad hoc solution in the Analysis Window 410 by adding one or more bid bands to the demand band. The created solution is partial in the sense that it does not fulfill the bundle demand yet.

At this point, the user can extend the partial solution to an optimal solution by using the Optimizer button 453 in the Result Window 450. This hybrid optimal solution can be also added to the Result Window 450 by using the Add button 451, and compared with other (ad hoc or optimal) solutions. This capability of creating a hybrid solution and comparing it with other types of solutions gives the user flexibility and opportunities to run diverse “what-if” scenarios, and to find the most appropriate solution for the given problem.

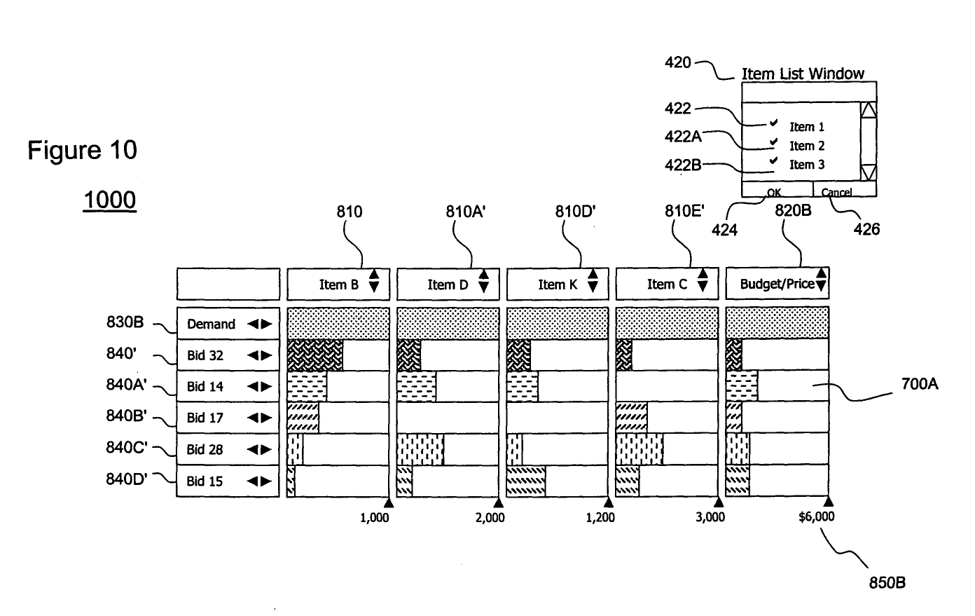

FIG. 10 illustrates a method 1000 for adding and deleting items in the analysis view. As explained above with regard to FIG. 4, the Item List Window 420 provides a list of all the items the user (i.e., buyer) hopes to procure and the demanded amount for each item.

Also, the Item List Window 420 allows the user to select or de-select one or more items by using the check-boxes (422, 422A and 422B) and the OK 424 and Cancel 426 buttons. Thus, the user can include, or exclude, particular items in the Analysis Window 410 in finding a solution. This capability for dynamic item selection is useful for running what-if scenarios in the Analysis Window 410.

As the bundle demand in the Analysis Window 410 is updated by the user's item selection operation in the Item List Window 420, the set of bundle bids displayed in the Analysis Window 410 is also updated. A bundle bid whose combination of items includes one that is not selected in the Item List Window 420 is not displayed in the Analysis Window 410. Thus, for example, in FIG. 10, Items A and F have been removed from the previous Figure (e.g., FIG. 9) using the Item List Window 420 by simply unchecking these items A and F in Window 420. This operation is coordinated from the analysis window and the items can be removed on the fly.

Thus, the Bridge Handler process 570 synchronizes the status between the Item List Window 420 and the Analysis Window 410. When an item is de-selected in the Item List Window 420 and the analysis view in the Analysis Window 410 is updated accordingly, because the Bridge Handler 570 catches this change in the Item List Window 420 and notifies it to the controller 562 of the Analysis Window 410, and then the controller can update the view 560 of the Analysis Window 410 to reflect the update in the Item List Window 420.

In the example shown in FIGS. 8 and 10, as briefly mentioned above, two items, Item A (810B) and Item F (810C), were de-selected in the Item List Window (420). To reflect this change, the view in the Analysis Window 410 is updated and remains with four items in FIG. 10, instead of six items in FIG. 8. Also, it is noted that to reflect the change in the bundle demand, the budget is accordingly updated to $6,000 (850B) from $9,000 (850).

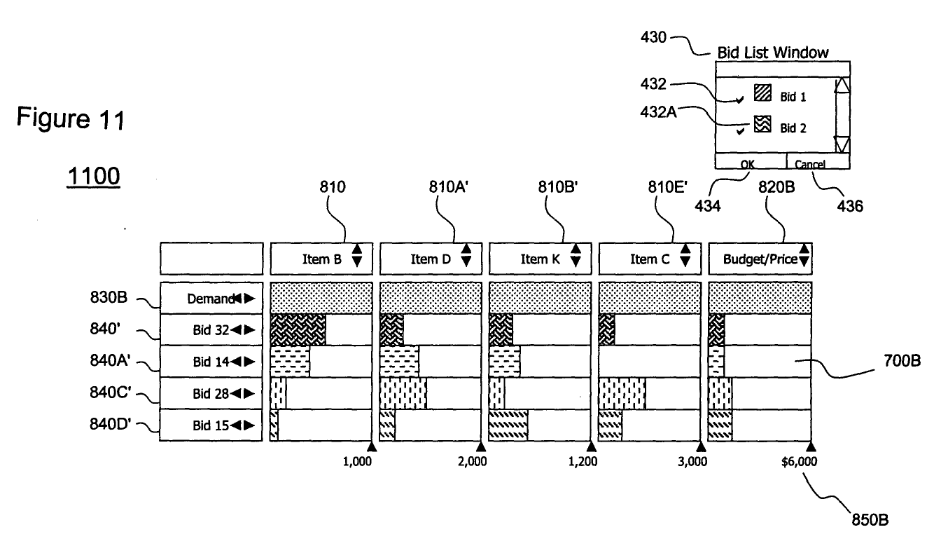

FIG. 11 illustrates a visualization 1100 for adding and deleting bids in the analysis view. In a similar way the Item List Window 420 is used, the Bid List Window 430 can be used to configure the combinatorial auction shown in the Analysis Window by adding and deleting one or more bundle bids.

The Bid List Window 430 displays a list of all the submitted bundle bids (along with their bundle price). It is noted that each bid entry (432 and 432A) is associated with a color or pattern-coded box that enables the user to easily match a bid in the Bid List Window 430 with one in the Analysis Window 410.

Also, the Bid List Window 430 allows the user to select or de-select one or more bids that the user wants to include or exclude, respectively, in the Analysis Window 410. For this bid selection and de-selection operation, the check-boxes (432 and 432A) and the OK 434 and Cancel 436 buttons are employed. This capability for dynamic bid selection is useful for running what-if scenarios in the Analysis Window 410.

Again, the Bridge Handler process 570 synchronizes the status between the Bid List Window 430 and the Analysis Window 410. When a bid is de-selected in the Bid List Window 430 and the analysis view in the Analysis Window 410 is updated accordingly, because the Bridge Handler 570 recognizes this change in the Bid List Window 430, and notifies it to the controller 562 of the Analysis Window 410, and then the controller can update the view 560 of the Analysis Window 410 to reflect the update in the Bid List Window 430.

In the example shown in FIGS. 10 and 11, one bid, Bid 17 (840B′) was de-selected in the Bid List Window 430. To reflect this change, the view in the Analysis Window 410 is updated and remains with four bids in FIG. 11, instead of five bids in FIG. 10.

FIG. 12 illustrates visualization 1200 in which a Constraint Window 440 is shown which includes a list of all the constraints applicable to the current auction setting presented in the Analysis Window 410.

Also, the Constraint Window 440 enables the user to dynamically update the values of various constraints and apply them to the bid evaluation in the Analysis Window 410.

Examples of constraints that can be set for a combinatorial reverse auction include limiting the minimum number of winning suppliers in a solution (e.g., to avoid dependency on too few suppliers), limiting the maximum number of winning suppliers in a solution (e.g., to avoid high transaction and overhead costs), limiting the minimum and/or maximum amount purchased from a particular supplier for a specific item, limiting the minimum and/or maximum amount purchased from a particular supplier in total, limiting the number of bids that can be submitted by a supplier, etc.

In the example shown in FIG. 12, the user can limit the minimum and maximum amount of four items (1210, 1210A, 1210B, and 1210C) for three suppliers (1230, 1230A, and 1230B). In addition, the user can limit the minimum and maximum of the total amount allocated to the three suppliers (1230, 1230A, and 1230B).

The user can dynamically change the minimum and maximum values by using the matching arrow glyphs (1240 and 1242) with a pointing device such as a computer mouse, a launch pad, a track-point, joystick, light pointer, track ball, etc.

That is, these arrow glyphs may be moved (slid) in one direction or another to change (e.g., reduce or increase) the distance between the first and second arrows, thereby to adjust an amount which a supplier will supply of the specific items (e.g., Item A, Item B, etc . . . ). If necessary, a text label (1244, 1260, and 1262) can be attached to each of the arrow glyph.

For example, it is noted that for a combinatorial auction there can be more than one winner (e.g., multiple winners), and “U” 1260 and “V” 1262 could represent the minimum and maximum dollar amounts which each winner may obtain.

Thus, for example, the user may decide that he/she does not wish to purchase more than a certain dollar amount with any one winning supplier, and likewise each winning supplier must receive a certain minimum dollar amount (e.g., in order to be a winning supplier). This will control the number of suppliers which are participating in the solutions.

Hence, any of these minimal and maximal conditions (e.g., items, dollar amounts, any attributes, etc.) can be easily managed, manipulated, and satisfied in this constraint window.

Another constraint example shown in FIG. 12 is limiting the minimum and maximum number of winning suppliers in a solution 1250. Once the user has configured the constraints displayed in the Constraint Window 440, the user can either record the setting (to enforce it later when generating a solution) or reset the view by using the OK 1270 or the Cancel button 1280, respectively. Another use of the Constraint Window 440 is that the user can monitor the fulfilled constraints in the window after they are enforced in generating a solution (either ad hoc or optimal).

FIG. 13 is a visual representation 1300 of solutions in the Result Window 450 showing two solutions groups (456 and 456′), one 456 (at the top) having three different solutions (457, 457A, and 457B) and the other two (457′ and 457A′) at the bottom of FIG. 13. Each group represents a different formulation of the demand. Once the demand is fixed, then solutions are created. If the user desires, the user can change the demand formulation, and then create some solutions for the new demand formulation. Additionally, it is possible to compare different groups. For each group, there may be multiple solutions.

The Result Window 450 groups and displays in a hierarchical tree structure (optimal and ad hoc) solutions for various combinatorial auction bid evaluation problems set up in the Analysis Window 410.

Under the root 455 of the tree structure, there can be one or more analysis groups 456. Each group represents a bid evaluation problem for a particular combinatorial auction setting displayed in the Analysis Window 410.

As explained above, the user can create a new bid evaluation problem by changing the values in the Item List Window 420, the Bid List Window 430, and the Constraint Window 440. Once a bid evaluation problem is determined in the Analysis Window 410, then it can added to the Result Window 450 as a group 456 by using the Add button 451. If necessary, a group can be deleted from the Result Window 450 by using the Delete button 452. For a bid evaluation problem, a user can generate an optimal solution by using the Allocation Optimizer 580, the conventional optimization technique described above with regard to FIG. 3.

A user can invoke the Allocation Optimizer 451 by using the Optimizer button 453 in the Result Window 450. In addition, the user can interactively generate one or more ad hoc solutions directly in the Analysis Window 410 by using visual operations as described above in detail with reference to FIG. 9. Generated solutions (either optimal or ad hoc) can be added to solution slots 457 in the Result Window 450. If necessary, a solution 457 in the Result Window 450 can be deleted by using the Delete button 452.

In the example shown in FIG. 13, the first analysis group 456 has three partial) solutions (457, 457A and 457B) over a bundle of six items. The Result Window 450 provides a visual representation of each solution. Also, the budget and the total price of each solution is visually represented 1320. In addition, embedded text 1330 shows the fulfilled amount of each item by the third solution 457B.

It is noted that, with regard to the total budget 1320 which is $10,000, all of the solutions are within the budget. That is, as shown in budget/price 1320, the first solution is $4,800, the second solution is $7,800, and the third solution is $5,800. Again, each possible solution is shown by a row. That is, each row represents a combination of bids, which is a possible solution.

It is noted that the solution 457 did not satisfy the demanded amount of Item K (1310D), whereas solution 457A did meet the demanded amount, and solution 457B over-satisfies the demand of Item K (1310D). In this case, the strip of this solution 457B for this item 1310D is filled by the total fulfilled amount by the solution (in this example, 1,500 units, which is more than the demanded amount, 1,200 units, as shown in FIG. 8). The initial demanded amount is indicated by a dotted line 1340 in the strip.

Thus, again, it is clear that solution 457B exceeded the initial demanded amount. Hence, the user can easily compare the possible solutions using the visualization according to the present invention, and can easily determine which solution exceeded (or did not exceed) the demanded amount.

It is noted that at the bottom of each Item there is an arrow and a number. For example, for Item B (1310), “700” represents the amount of units fulfilled by the solution. Thus, for item B, solution 457B did not fulfill the demanded amount. The case is similar for items D, A, F, and C.

The second analysis group 456′ also provides an example of an over-satisfied demand in a solution 457A′ for Item Q. Again, the initial demanded amount is indicated by a dotted line 1340′ in the strip. It is noted that some solutions may over-satisfy demand. If there is no holding cost, this may be acceptable or even desirable.

Also it is noted that, as in the Analysis Window 410, the Result Window 450 provides the sorting buttons in the item headers (1310, 1310A, 1310B, 1310C, 1310D, and 1310E). By using these sorting buttons, a user can sort (e.g., in either an ascending or a descending order) the displayed solutions and compare them.

It is noted that the solutions shown in FIG. 13 can be looked upon as dynamic solutions. That is, for example, solution 457 does not meet the requested demanded amount, and thus this is not a completed solution, but is one which the user is currently working on (e.g., on going). Hence, the combination of each bid results in a current price which is relatively low (e.g., $4,800). In the next iteration, the user can add another bid, and the price for the new combination would presumably increase.

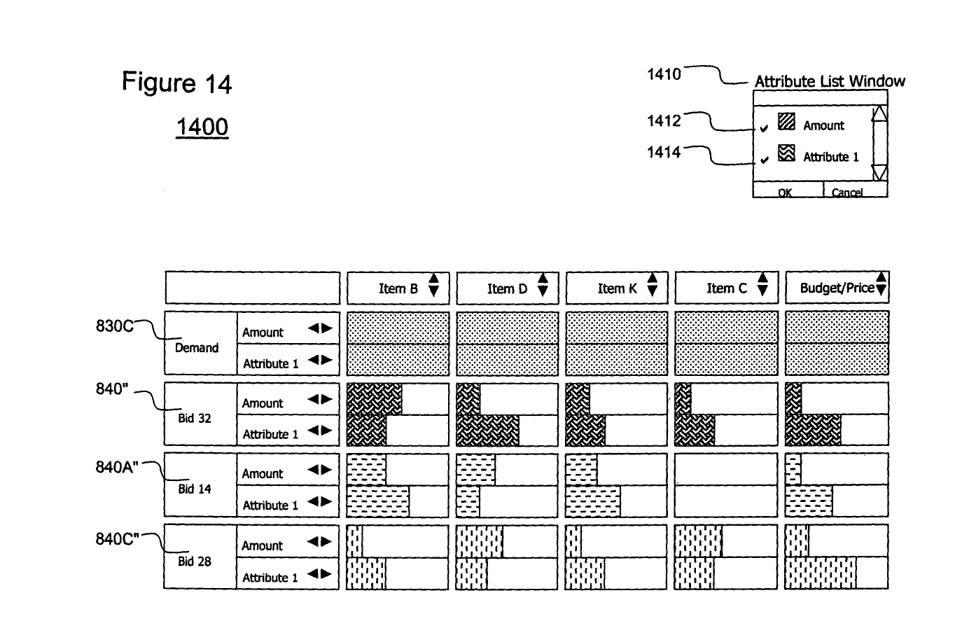

FIG. 14 is a visualization 1400 which illustrates adding and deleting attributes in the analysis view. Each item may have one or more types of attributes, as well as an amount as described above. Hereinbefore, it has been assumed that all of the attributes of the items have been the same, but in real world applications this is not necessarily the case.

For example, if the item is a chemical product such as a plastic, an attribute may be the melting point of a particular plastic, or how quickly the plastic is disposed, etc. Another example may be if the item is a car, an attribute may be the horsepower of the engine, fuel economy of the car, different types of options, etc. There may be many different attributes for each item. Thus, while not shown in earlier Figures described above, an attribute list window 410 may be provided as shown in FIG. 14.

That is, as described above with regard to FIG. 4, the information about various attributes of the demanded items and of the bidded products (or services) can be displayed in the Attribute Information section 486 and the Product Information section 496 of the Item Detail Window 480 and the Bid Detail Window 490, respectively.

Additionally, as mentioned above, the Attribute List Window 1410 can be provided. The Attribute List Window 1410 will be used in a similar way as the Item List Window 420 and the Bid List Window 430. It provides a list of all the attributes of the items shown in the Analysis Window 410. Also, it allows the user to select or de-select one or more attributes by using the check-boxes (1412, 1414) and the OK and Cancel buttons.

It is noted that the original visual representation of combinatorial auctions 700 displays only a single attribute for the demand and bids (i.e., amount for each item). With the introduction of the Attribute List Window 1410, the amount of each item is still the default attribute. In addition, however, a user can view one or more of other attributes along with the default attribute. When an attribute is selected in the Attribute List Window 1410, a band is added to the demand and each of the bids for displaying the attribute values.

In the example of FIG. 14, an attribute (i.e., Attribute 1 (1414)) is selected in the Attribute List Window 1410) (as well as the “amount”). Accordingly, a new band for Attribute 1 is added to the demand 830C) and each of the bids (840″, 840A″, and 840C″).

The newly added band for a bid displays the attribute values for each item in the bid. It is noted that the superimpose (drag-and-drop) operation that overlays the bands of bids on the demand band, explained above with reference to FIG. 9, works for the bands for added attributes. Using this operation, a user can superimpose two or more bid bands on the demand band for an attribute, and visually compare their values.

Also, it is noted that, in the example of FIG. 14, the same color is used for each bid (i.e., the color-coding is used to distinguish only different bids), and no distinction is made between attributes. However, it is possible to add another dimension to the color-coding scheme (e.g., a pattern-coding on top of a color-coding) to visually differentiate bids and attributes. The use of the Attribute List Window 1410 and the visual representation of combinatorial auctions augmented by multiple attribute bands will enable the user to perform preliminary analysis on bids based on multiple attributes, and so enable the user to make more informed purchasing decisions.

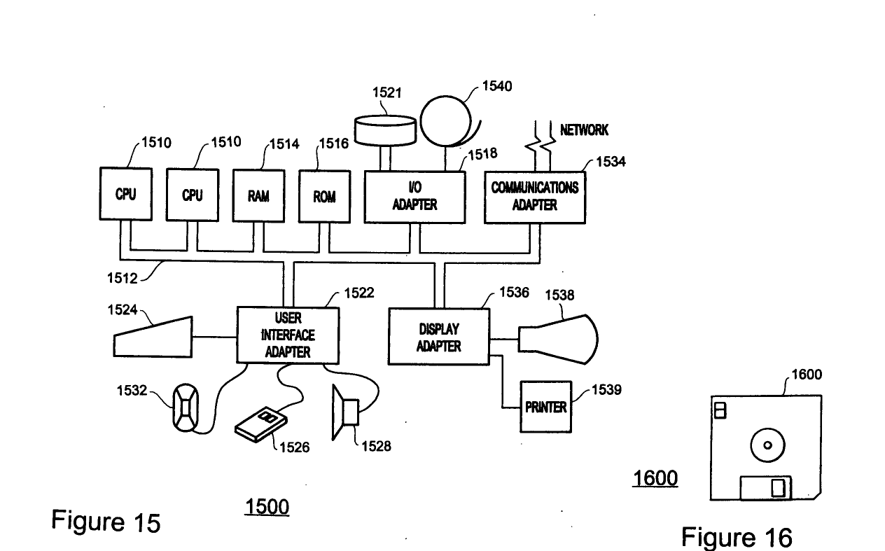

FIG. 15 illustrates a typical hardware configuration of an information handling/computer system for use with the invention and which preferably has at least one processor or central processing unit (CPU) 1511.

The CPUs 1511 are interconnected via a system bus 1512 to a random access memory (RAM) 514, read-only memory (ROM) 1516, input/output (I/O) adapter 1518 (for connecting peripheral devices such as disk units 1521 and tape drives 1540 to the bus 1512), user interface adapter 1522 (for connecting a keyboard 1524, mouse 1526, speaker 1528, microphone 1532, and/or other user interface device to the bus 1512), a communication adapter 1534 for connecting an information handling system to a data processing network, the Internet, an Intranet, a personal area network (PAN), etc., and a display adapter 1536 for connecting the bus 1512 to a display device 1538 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 1511, as represented by the fast-access storage for example. Alternatively, the instructions may be contained in another signal-bearing media, such as a magnetic data storage diskette 1600 (FIG. 16), directly or indirectly accessible by the CPU 1511.

Whether contained in the diskette 1600, the computer/CPU 1511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

With the unique and unobvious features of the present invention, the user can clearly and simply understand how the provided solution minimizes the total purchase price and how it satisfies the demand for each item and all the given constraints, even when there are an increased number of bids and purchased items, and when there are an increased number and types of constraints.

Additionally, supporting information (e.g., items, bids, constraints, analysis, and results) can be provided, as well as optimal solutions, that help a user understand and investigate why the solution from the bid evaluation system is optimal and how it satisfies the demand for each item and all the given constraints.

Further, the user interface according to the invention presents solutions and supporting information in an intuitively understandable visual representation, and provides visual operations on graphical entities of the visual representation.

Moreover, the user can interactively generate ad hoc solutions by using visual operations, for comparing them with the machine-generated optimal solution. By comparing ad hoc solutions and the machine-generated solution, the user can understand how the optimal solution is better than ad hoc ones, and what are the factors that affected the result.

Additionally, the user interface can enable a user to dynamically update auction parameters (e.g., including items in it, bundle bids under consideration, and constraints) and generate (e.g., both ad hoc and optimal) solutions iteratively for a what-if analysis. Going through various what-if scenarios, the user can understand factors that affect the auction result, and reformulate the auction with a different parameter setting to save cost and/or satisfy other possible conditions.

Finally, with the present invention, a user can generate an optimal solution for an auction after pre-assigning one or more bundle bids to the winning bid pool, and the user interface can provide one or more recommendations on what actions to take next in generating ad hoc solution and enable the user to enforce one or more recommendations by using a pointing device such as computer mouse.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

1. An interactive bid evaluation system for a combinatorial auction, comprising:
a display for scaling a plurality of bids and items, on a display window.

2. The system of claim 1, wherein said display scales viewable objects representing said bids and items, such that as a number of bids and items increases, a size of said viewable objects representing said bids and objects decreases.

3. The system of claim 1, wherein each of said bids and items is displayed, regardless of a number of said bids and items.

4. The system of claim 1, wherein said display includes a real-time recommendation window for providing at least one recommendation on what action to take next in generating an ad hoc solution.

5. The system of claim 1, wherein said display displays supporting information including any of items, bids, constraints, analysis, and results, and candidate optimal solutions on said display, to allow interactive selection of an optimal solution from the bid evaluation system,
said supporting information providing a visualization of how the optimal solution satisfies a demand for each item and each constraint thereon.

6. The system of claim 1, wherein said display comprises a user interface for presenting solutions and supporting information in an intuitively understandable visual representation, and for providing visual operations on graphical entities of the visual representation.

7. The system of claim 1, further comprising a processor coupled to said display,
wherein said display comprises a mechanism for enabling a user to interactively generate an ad hoc solution by using visual operations, and for comparing the solutions with an optimal solution generated by said processor.

8. The system of claim 1, wherein said display includes:
a dynamic mechanism for enabling a user to dynamically update auction parameters including any of items in the auction, bundle bids under consideration, and changing constraints and a reserve price; and
a mechanism for generating ad hoc and optimal solutions iteratively for exploratory analysis.

9. The system of claim 1, wherein said display includes a mechanism for enabling a user to generate interactively an optimal solution for an auction after pre-assigning at least one bundle bid to a winning bid pool.

10. The system of claim 4, further comprising a user input device coupled to said display,
wherein said display includes a mechanism for enabling a user to enforce said at least one recommendation by using said user input device.

11. The system of claim 1, wherein said display comprises an iconic user interface including an analysis window which allows said scaling.

12. The system of claim 11, wherein said iconic user interface further comprises any of an item list window, a bid list window, a constraint window, a result window, a result detail window, a recommendation window, an item detail window, and a bid detail Window interactively coupled to said analysis window.

13. The system of claim 12, wherein said analysis window displays a bundle demand and a set of submitted bundle bids,
wherein said item list window displays a list of all items the user desires to procure and a demanded amount for each item,
said item list window allowing the user to any of select and de-select at least one item that the user desires to any of include and exclude, respectively, in the analysis window, and
wherein, as the bundle demand in the analysis window is updated by the user's item selection operation in the item list window, the set of bundle bids displayed in the analysis window is updated.

14. The system of claim 12, further comprising a pointing device, wherein said item detail window is openable from the item list window by using an operation of said pointing device,
said item detail window for displaying information about a particular item,
wherein said bid list window displays a list of all the submitted bundle bids and allows the user to any of select and de-select at least one bid that the user wants to any of include and exclude, respectively, in the analysis window, and
wherein said bid detail window is openable from the bid list window by using an operation of said pointing device, and displays various information about a particular bid, including a bid thumbnail image, a supplier information, and a product information bundled in a bid.

15. The system of claim 14, wherein the constraint window displays a list of constraints applicable to the current auction setting presented in the analysis window, and enables the user to dynamically update values of constraints and apply the values to the bid evaluation in the analysis window,
wherein the result window groups and displays, in a hierarchical tree structure, solutions for various combinatorial auction bid evaluation problems set up in the analysis window, so as to classify different solutions hierarchically in the result window,
wherein a new bid evaluation problem is created by changing the values in the item list window, the bid list window, and the constraint window, and
wherein when a bid evaluation problem is determined in the analysis window, said bid evaluation problem is selectively added to the result window.

16. The system of claim 15, wherein the result detail window is openable from the result window by using said pointing device to present detailed information on a particular solution,
wherein the recommendation window provides at least one recommendation for each iteration in generating an ad hoc solution for a combinatorial auction bid evaluation problem, to allow said user to directly enforce the recommendation in the recommendation window, and
wherein if a predetermined supplier makes a bid, then said bid by said predetermined supplier is automatically selected.

17. A method of interactive bid evaluation for a combinatorial auction, comprising:
scaling a plurality of bids and items displayed on a display window.

18. The method of claim 17, wherein said scaling comprises scaling viewable objects representing said bids and items such that as a number of bids and items increases, a size of said viewable objects representing said bids and items decreases.

19. The method of claim 17, wherein each of said bids and items is displayed regardless of a number of said bids and items, said method further comprising:
providing a real-time recommendation window for providing at least one recommendation on what action to take next in generating an ad hoc solution;
displaying supporting information including any of items, bids, constraints, analysis, and results, and optimal solutions on said displays, to allow interactive selection of an optimal solution from the bid evaluation system, said supporting informant providing a visualization of how the optimal solution satisfies a demand for each item and each constraint thereon;
presenting solutions and supporting information in an intuitively understandable visual representation, and providing visual operations on graphical entities of the visual representation;
interactively generating, by a user, an ad hoc solution by using visual operations, and comparing the solutions with a computer-generated optimal solution;
enabling a user to dynamically update auction parameters including 5 any of items in the auction, bundle bids under consideration, and changing constraints and a reserve price, and generating ad hoc and optimal solutions iteratively for exploratory analysis;
generating interactively an optimal solution for an auction after pre-assigning at least one bundle bid to a winning bid pool; and
enforcing at least one recommendation by using said user input device.

20. A signal-bearing medium tangibly embodying a program of machine-readable instructions executable by a digital processing apparatus to perform a method of interactive bid evaluation for a combinatorial auction according to claim 17.

21. A method of deploying computing infrastructure in which computer-readable code is integrated into a computing system, such that said code and said computing system combine to perform a method of interactive bid evaluation for a combinatorial auction, according to claim 17.

22. A method of evaluating bids in a combinatorial auction, comprising: structuring bid and item information on a visual interface of a display; and
providing an analysis capability for facilitating evaluation and selection of at least one solution encompassing bids,
wherein said visual interface allows a user to directly manipulate data points in the visual interface to explore an information space of potential solutions and suppliers and to discover at least one solution optimal to the user's needs.

23. A signal-bearing medium tangibly embodying a program of machine-readable instructions executable by a digital processing apparatus to perform a method of evaluating bids in a combinatorial auction according to claim 17.

24. A method of deploying computing infrastructure in which computer-readable code is integrated into a computing system, such that said code and said computing system combine to perform a method of evaluating bids in a combinatorial auction according to claim 17.
